(19) United States
(12) Patent Application Publication
(10) Pub. No.: US 2007/0101386 A1
(43) Pub. Date: May 3, 2007

(54) Interactive developmental educational and entertainment system

(75) Inventors: Guy Oranim, Kfar Shmaryahoo (IL); Sharon Rechter, Kfar Shmaryahoo (IL)

Correspondence Address: TIAJOLOFF & KELLY, CHRYSLER BUILDING, 37TH FLOOR, 405 LEXINGTON AVENUE, NEW YORK, NY, 10174, US

(73) Assignee: BFTV LLC, New York, NY (US)

(21) Appl. No.: 11/265,765

(22) Filed: Nov. 1, 2005

(51) Int. Cl. H04N 7/173; H04N 7/20; H04N 7/16

(52) U.S. Cl. 725/113; 725/129; 725/112; 725/63; 725/115; 725/145

(57) ABSTRACT

A developmental, educational and entertainment system has a main module comprising a display, a computer or an interactive communication device or combination thereof, in which interactive applications are installed. A first remote control device controls the applications in the main module, and a second remote control device interacts with the applications in the main module. A remote control device suitable for use by infants comprises a button panel with 3 to 10 large buttons, that are removable so that buttons with various symbols can be inserted into the button panel, depending on the application, and optionally, the complete panel with the buttons is removable and interchangeable with other panels of buttons.

### FIELD OF THE INVENTION

The present invention relates to the field of interactive developmental, educational and entertainment systems, more particularly to interactive television and computer systems for infants.

### BACKGROUND OF THE INVENTION

In the world of electronic developmental, educational and entertainment systems (hereinafter “DEE system”) and particularly interactive systems, it has been accepted there are specific entertainment channels tailored to the specific needs of specific audiences. One such group is the age group of infants the term “infant” is used synonymous with “toddler” and encompasses children in the age group of 6 months to 4 years old). A plethora of applications, systems and hardware that are specifically constructed for toddlers are available commercially—For example, the ComFi® keyboard and the like. However, the setup and control of the systems and applications of the prior art, generally require the adult to intervene with the toddlers activity. Several disadvantages of this are: a) inconveniencing the toddler, b) obstructing the toddler's attention and concentration, and c) the adult needs to use the toddler's hardware and interfacing for setting up and activating the application, which can be inconvenient for use by an adult. Furthermore, the structure of hardware intended for use by toddlers must be such which correlates to the cognitive and motor skills of the average user. Hence, toddlers who generally possess relatively basic motor skills, and may find it difficult to operate conventional remote controls would respond better to an interactive system if they had a remote control constructed to match with the toddlers' motor and cognitive skills. For example, the toddler's motor skills are not developed enough to press a button with a single finger or two, so he is able to press down on a button only with several fingers or the entire palm of the hand. Currently, there are applications intended for toddlers however, the interactivity of said applications is limited by the means provided to the user (toddler) for interacting with the application.

Accordingly, there is a long felt need for an electronic interactive developmental, educational and entertainment system for infants, which enables the adult to control the applications and the set up, while enabling the user infant to interact with the system and application via a custom tailored device, wherein the activities of one do not interrupt the activities of the other.

It is therefore an objective of the present invention to provide an interactive DEE system for infants which enables simultaneous operations to be carried out by the infant and the supervising adult.

It is a further purpose of the present invention to provide a unique remote control device suitable for the use of infants.

It is yet a further purpose of the present invention to provide a method for operating an interactive DEE system suitable for infants.

Other objectives of the invention shall become apparent as the description proceeds.

### SUMMARY OF THE INVENTION

The present invention provides a developmental, educational and entertainment system comprising; a) a main module comprising a display, a computer or an interactive communication device or combination thereof, in which interactive applications are installed; b) a first remote control device for controlling the applications in the main module; and c) a second remote control device for interacting with the applications in the main module. Further provided by the present invention is a remote control device (hereinafter also referred to as “second remote control”) suitable for use by infants comprising a button panel with 3 to 10 buttons, wherein said buttons are large. Furthermore, the buttons are removable so that buttons with various symbols can be inserted into the button panel, depending on the application. Optionally, the complete panel with the buttons is removable and interchangeable with other panels comprising buttons. Said remote control device is preferably equipped with more than one transmitter in order to provide successful communication between the remote control device and the main module.

Further provided by the present invention is a dual operating method for operating an interactive developmental, educational and entertainment system characterized in that the main module of the system and the application are controlled by a first remote control device and the interactive entertainment activity of the system is by means of a second remote control device.

### BRIEF DESCRIPTIONS OF THE DRAWING

FIG. 1A—drawing depicting the components of the system of the present invention and use thereof by an infant.

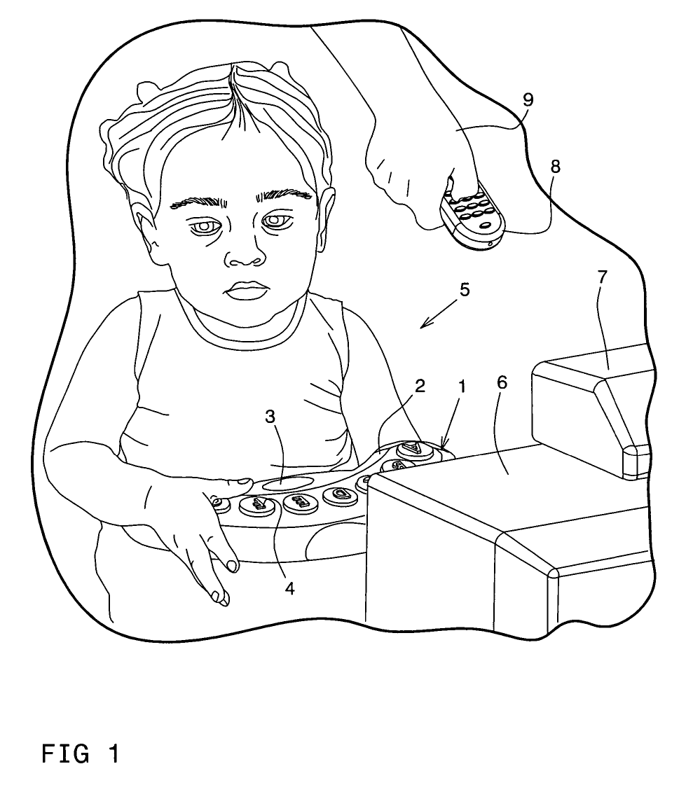

FIG. 2—A plan view of the second remote control of the system.

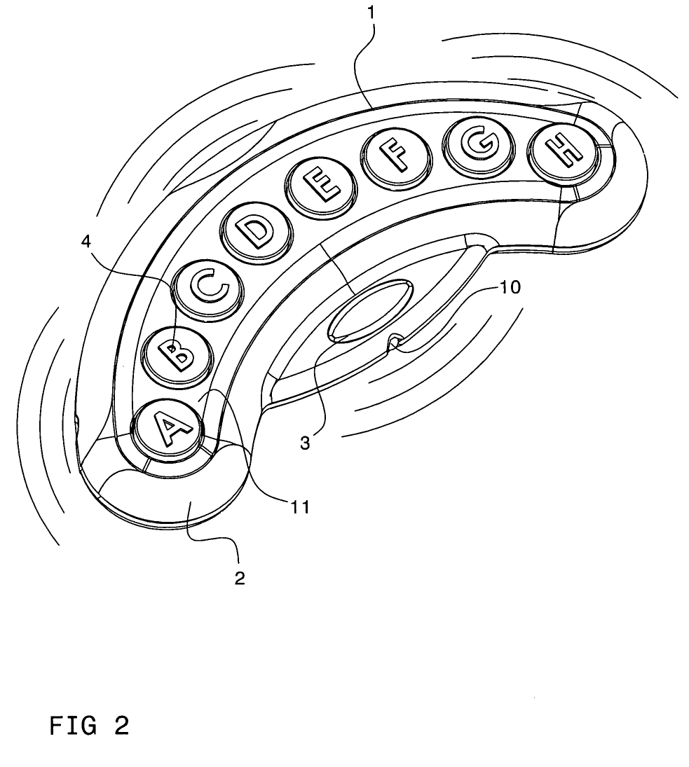

FIG. 3—A cross section of the second remote control.

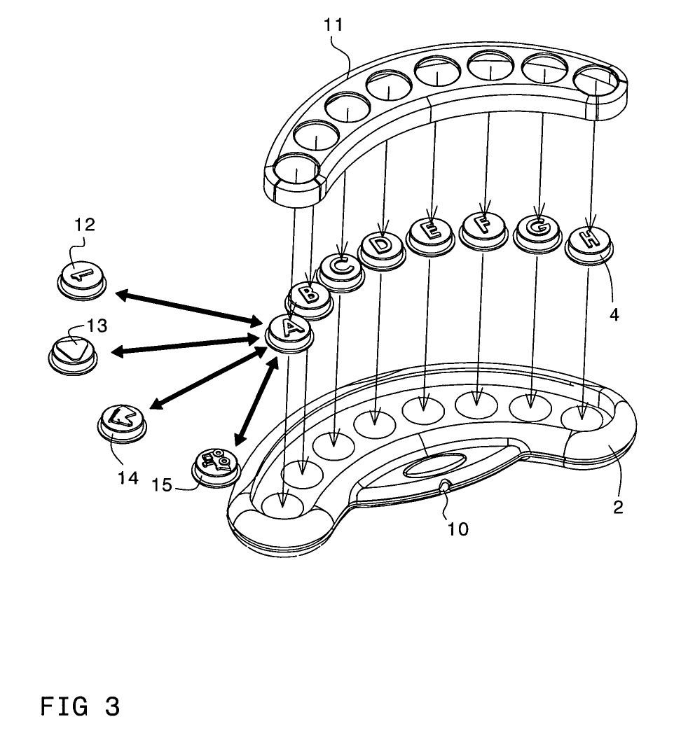

FIG. 4—A plan view of the back of the second remote control.

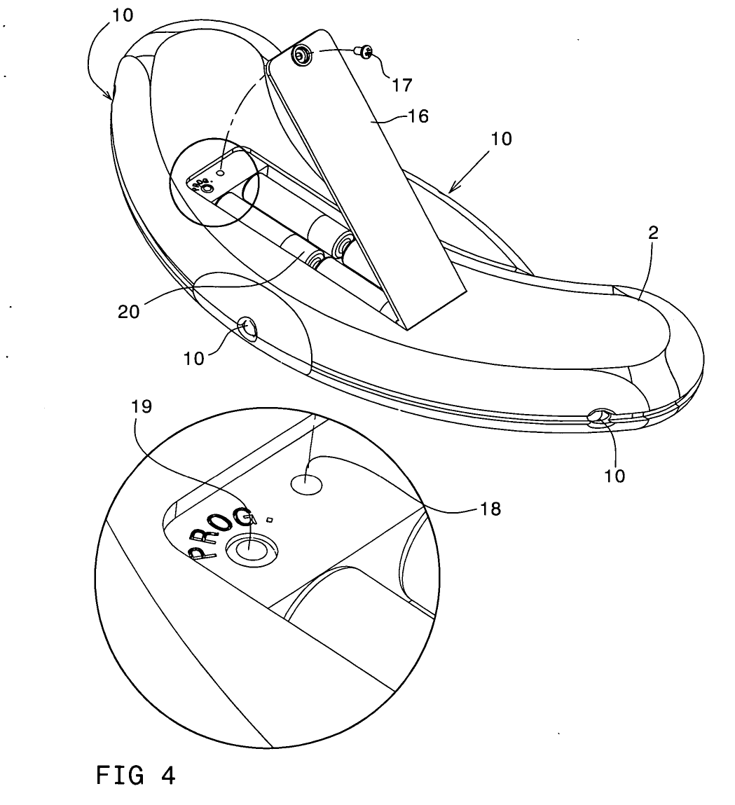

FIG. 5—A scheme of the system.

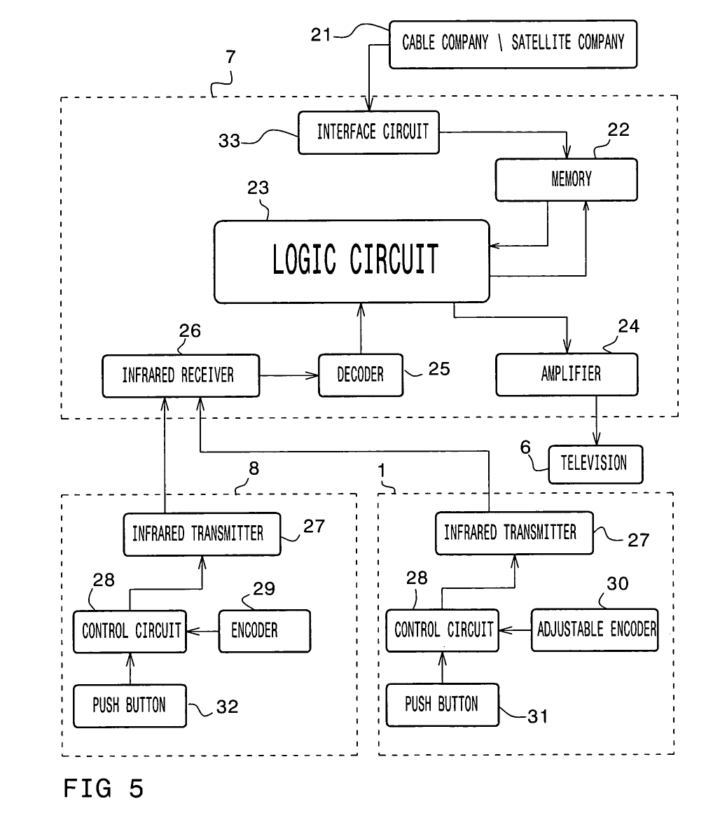

FIG. 6—A front view of the system.

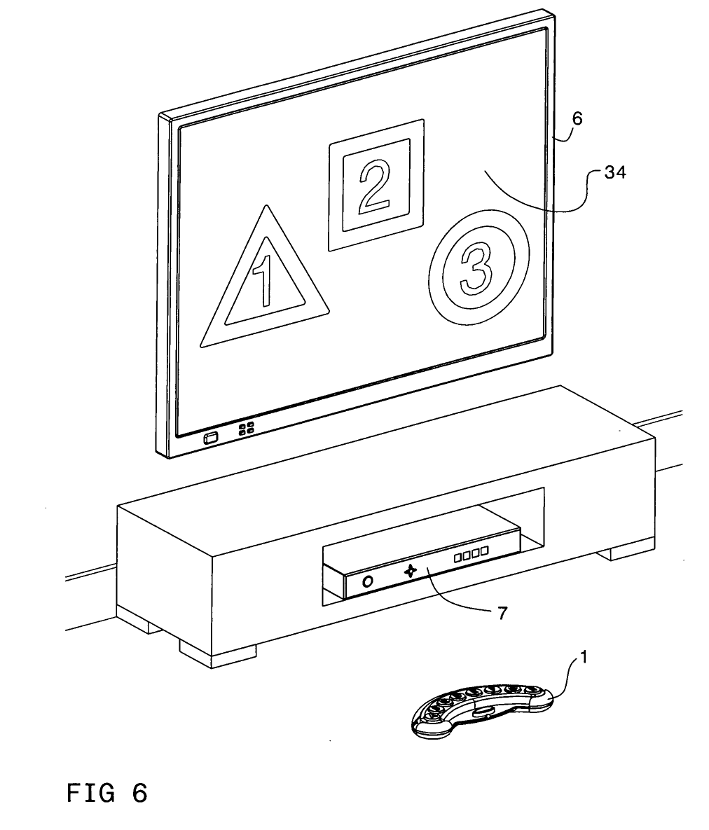

### DETAILED DESCRIPTION OF PREFERRED EMBODIMENTS

The following description is illustrative of embodiments of the invention with reference to the numbering of the Figures. The following description is not to be construed as limiting, it being understood that the skilled person may carry out many obvious variations to the invention.

The present invention provides a developmental, educational & entertainment system tailored for use by infants (throughout the specification, the term “infant” is used synonymous with “toddler” and encompasses children in the age group of 6 months to 4 years old). The term “large” with respect to the buttons of said second remote control refer a size larger than conventional buttons on remote controls and a size which enables convenient operation of said remote control by the intended age group. The system is specifically tailored for infants' use in that it provides a unique remote control device designed for use by infants which enables the infant to interact with an interactive application that is installed on the main module wherein said main module comprises a display and an interactive communication device, wherein said main module may be a television connected to a service provider via a digital converter or similar device or a computer. The system of the present invention comprises; a) a main module comprising a display which is a television (6), a computer or combination thereof, in which interactive applications are installed; b) a first remote control device (8) for controlling the applications in the main module; and c) a second remote control device (1) for interacting with the applications in the main module. Throughout the specification the term television (TV) includes TV systems that are televisions connected to service providers such as cable companies, cable networks, satellite telecommunication companies, satellite networks, Internet Protocol Based TV (IPTV) companies and networks, Fiber to The Premises (FTTP) companies and networks or any other type of provider which can provide interactive applications. Further non-limiting examples of said providers are internet companies such as Yahoo® and the like.

In accordance with a specific embodiment of the system of the present invention the system comprises the following components:

a) a main module comprising a TV (6) and a digital converter (7) as an interface between the service provider and the TV. Said digital converter (what about a compute?) comprises an interface circuit (33) which receives the signal, data or broadcast (hereinafter collectively referred to as data) from the service provider (21) and sends said data to the logic circuit (23) via the memory component (22). Upon processing the data the logic circuit (23) transfers the data to the TV (6) via an amplifier (24) where the data is displayed as images, sounds or other characters of the interactive application which is being run on the TV (6).

b) a first remote control (8) which is intended for the use of the person (9) who is intended for setting up and controlling the applications which are run on the TV (6). Said first remote control (8) comprises a button panel (32), a control circuit (28), encoder (29) and infrared transmitter (27). Said remote control can be of the commercial type which is provided by the cable/satellite service provider with the digital converter.

c) a second remote control (1), claimed herein, intended for use of an infant (5) wherein said second remote control (1) enables interaction between the infant (5) and the application installed on the main module TV (6). Said second remote control comprises a button panel (31), a control circuit (28), adjustable encoder (30) and infrared transmitter (27). Wherein said adjustable encoder provides the ability to adjust the remote control so that it can operate a wide variety of digital converters or similar devices.

According to yet a further embodiment of the invention, the main module of said DEE system can be a computer which contains interactive applications already installed on said computer, or a computer which is connected to a network that provides interactive applications, examples of such networks being the internet or a local network in an educational institution or the like. According to an optional embodiment, the first remote control may be replaced by a keyboard and mouse.

According to one specific embodiment of the invention, the interactive application of the main module includes various applications which are based on TV channel's content and series, e.g., simple interactions as with regular toys. For example the infant plays with the remote control like a regular toy wherein every action of the remote control by the infant results in a positive reaction, e.g, playing a tune via the remote control (every button on the remote control represents a series of musical notes); creating with the remote control the voices of various animals etc. Further exemplary non-limiting options for applications include an application with simple riddles wherein, for example the infant is encouraged to guess which geometrical shape appears on the screen or how many chickens there are in the farm etc. A wide variety of applications with various interactive activities can be used on the present DEE system, as appreciated by the skilled person.

Further provided by the present invention is said second remote control device (1) suitable for use by infants (5) comprising a button panel (11) which can be removable and comprises 3 to 10 buttons (4),(12),(13),(14),(15) wherein said buttons are of a size which facilitates the toddlers, operating of said remote control. The buttons (4),(12),(13),(14),(15) are removable so that buttons with various symbols (4),(12),(13),(14),(15) can be inserted into the button panel (11), depending on the application requirements. According to a further optional embodiment, the button panel contains buttons which are fixed into the panel and the complete panel is removable such that it may be interchangeable with other panels containing buttons with characters, symbols or colors different from the other panels. The body (2) of said second remote control is preferably shaped in a shape which is convenient for handling by subjects with relatively limited motor skills, such as infants, wherein said shape can be crescent shape. The buttons in the button panel (11) are arranged in a manner which facilitates the operating of said buttons, for example the shape of a crescent wherein the body (2) of said remote control is in the same shape. The buttons may bear various symbols or may be of different colors in accordance with the application with which the subject is interacting. Non-limiting examples include buttons which may bear letters (4), numbers (12), shapes (13), depictions of animals (14) and vehicles (15). Said buttons are interchangeable by removing the button panel (11) and replacing the buttons with other buttons with different characters, colors or symbols, or by replacing the complete panel including the buttons with different panels which already contains other buttons.

In accordance with a particular embodiment of said second remote control presently claimed, said remote control is equipped with more than one transmitter (10), wherein said transmitters are positioned on different sides of said remote control in order to provide full directional coverage (360 degrees) of the remote control's transmission. Hence, the transmission of a signal from said remote control to the main module is successful, regardless of the position in which said remote control is held.

Said remote control further comprises a program button (19) which enables for programming said remote control for compatibility with various digital converters. For safety reasons said programming button may be optionally positioned under the battery cover (16) which is secured by screwing the cover screw (17) into the corresponding hole (18) in the body of said remote control.

According to a further embodiment of the present invention, said remote control comprises a cylinder shaped roller (3). Said roller requires the user (toddler) to engage different motor skills from those required to operate buttons, so that said roller provides an additional developmental feature. Said roller can provide similar functions as the buttons. For example, rolling of said roller may generate a response, animation or any other feature in the interactive application.

Optionally, said second remote control may function as a toy for an infant when it is constructed in various colors and is further equipped with playful features such as a roller wheel and the like.

According to a further embodiment of said remote control, said remote control preferably comprises a protective layer surrounding the edges of said remote control in order to protect it from impact as a result of a fall or being thrown by the infant. Said protective layer may be constructed of various impact-absorbing materials or combinations thereof as appreciated by the skilled artisan. Non-limiting examples of such materials are rubber, silicone, high impact polymers and the like. According to a certain embodiments of the invention, said second remote control may be constructed of various suitable materials as maybe appreciated by the skilled artisan.

Further provided by the present invention is a method for operating an interactive entertainment system characterized in that the main module of the system and the application are controlled by a first remote control device and the interactive entertainment activity with the system is by means of a second remote control device.

The operating methodology in accordance with the present invention is tailored to the limited motor and cognitive skills of infants. They can neither activate the interactive application nor choose the application they want to play with by themselves. Therefore, the method is based on the “dual-operating” methodology wherein the parent uses the first (“regular”) TV remote-control to enter the interactive layer or application, choose the relevant interactive applications, the relevant level of difficulty etc. Once the application is chosen, the parent can run it and then the infant can interact with the application via the second remote control (specially described and claimed herein). The infant can operate the application but he cannot stop or change it. Similar methodology is applied to run the TV and/or computer based applications. According to a particular embodiment the second remote control cannot activate setup features of the interactive communication device, e.g. digital converter, thus securing that all setup features are controlled only by the operator of the first remote control.

While embodiments of the invention have been described by way of illustration, it will be apparent that the invention may be carried out with many modifications, variations and adaptations, without departing from its spirit or exceeding the scope of the claims.

It should be understood that some modification, alteration and substitution is anticipated and expected from those skilled in the art without departing from the teachings of the invention. Accordingly, it is appropriate that the following claims be construed broadly and in a manner consistent with the scope and spirit of the invention.

1. A developmental, educational and entertainment system comprising; a) a main module comprising a display, a computer or an interactive communication device or combination thereof, in which interactive applications are installed; b) a first remote control device for controlling the applications in the main module; and c) a second remote control device for interacting with the applications in the main module.

2. A system according to claim 1 wherein the main module comprises a television as a display and an interactive communication device wherein the television is connected via an interactive communication device to a service provider or a computer which has applications installed or is connected to a service provider.

3. A system according to claim 2 wherein the television is connected to a service provider via a digital converter.

4. A system according to claim 2 wherein the service provider is selected from among cable, satellite, local computer networks, internet-based companies and cable or satellite companies and Internet Protocol based TV (IPTV) companies and networks, Fiber to The Premises (FTTP) companies and networks.

5. A system according to claim 1 wherein said second remote control device is suitable for use by infants.

6. A system according to claim 1 wherein the display is a computer screen and the interactive communication device is a computer which is connected to a service provider.

7. A system according to claim 1 wherein said applications are provided by satellite, cable or internet companies.

8. A remote control device suitable for use by infants comprising a button panel with 3 to 10 buttons, wherein said buttons are large.

9. A device according to claim 8 wherein said buttons are removable so that buttons with various symbols, colors or characters can be inserted into the button panel.

10. A device according to claim 8 wherein the buttons are part of the panel and the panel is removable.

11. A remote control device in accordance to claim 8 further equipped with more than one transmitter.

12. A method for operating an interactive entertainment system characterized in that the main module of the system and the application are controlled by a first remote control device and the interactive entertainment activity of the system is by means of a second remote control device.
